(19) United States
(12) Patent Application Publication
(10) Pub. No.: US 2024/0025352 A1
(43) Pub. Date: Jan. 25, 2024

(54) OCCUPANT MONITORING SYSTEM

(71) Applicant: DENSO CORPORATION, Kariya-city (JP)

(72) Inventor: Kiyotaka TAGUCHI, Kariya-city (JP)

(21) Appl. No.: 18/481,207

(22) Filed: Oct. 4, 2023

Related U.S. Application Data
(63) Continuation of application No. PCT/JP2022/013560, filed on Mar. 23, 2022.

(30) Foreign Application Priority Data
Apr. 14, 2021 (JP) 2021-068432

(51) Int. Cl. B60R 11/04; G06V 20/59

(52) U.S. Cl. CPC B60R 11/04; G06V 20/593; B60R 2011/0003

(57) ABSTRACT

An occupant monitoring system includes a camera unit provided in a vehicle compartment and captures an image of a face of an occupant in a vehicle as an imaging target. The camera unit includes a camera and a light source on a substrate. The camera forms a light path in which light from the light source is transmitted through a design surface to irradiate the imaging target and light reflected from the imaging target is transmitted through the design surface to be input to the camera. The camera unit includes a path prevention structure which prevents light from entering the camera through a path other than the light path.

### CROSS REFERENCE TO RELATED APPLICATIONS

The present application is a continuation application of International Patent Application No. PCT/JP2022/013560 filed on Mar. 23, 2022, which designated the U.S. and claims the benefit of priority from Japanese Patent Application No. 2021-068432 filed on Apr. 14, 2021. The entire disclosures of all of the above applications are incorporated herein by reference.

### TECHNICAL FIELD

The present disclosure relates to an occupant monitoring system including a camera unit that is provided in a vehicle compartment and captures an image of a face of an occupant in a vehicle as an imaging target.

### BACKGROUND

An occupant monitoring system captures an image of an occupant's face with a camera and recognizes the occupant's face based on the captured data.

### SUMMARY

According to at least one embodiment, an occupant monitoring system includes a camera unit provided in a vehicle compartment and captures an image of a face of an occupant in a vehicle as an imaging target. The camera unit includes a camera and a light source on a substrate. The camera forms a light path in which light from the light source is transmitted through a design surface to irradiate the imaging target and light reflected from the imaging target is transmitted through the design surface to be input to the camera. The camera unit includes a path prevention structure which prevents light from entering the camera through a path other than the light path.

### BRIEF DESCRIPTION OF DRAWINGS

The details of one or more embodiments are set forth in the accompanying drawings and the description below. Other features and advantages will be apparent from the description and drawings, and from the claims.

The above and other objects, features and advantages of the present disclosure will become more apparent from the following detailed description made with reference to the accompanying drawings. In the drawings,

FIG. 1 is a plan view illustrating an arrangement of a camera unit according to a first embodiment;

FIG. 2 is an enlarged plan view of a part of the camera unit;

FIG. 3 is a front view of a part of an instrument panel in a vehicle compartment;

FIG. 4 is a perspective view schematically illustrating an overall configuration of a system;

FIG. 5 is a flowchart showing a procedure of image recognition, and

FIG. 6 is a perspective view of a part of a camera unit according to a second embodiment.

### DETAILED DESCRIPTION

To begin with, examples of relevant techniques will be described.

In recent years, a vehicle such as an automobile has been equipped with an occupant monitoring system that captures an image of an occupant's face with a camera and recognizes the occupant's face based on the captured data. This occupant monitoring system according to a comparative example is configured such that a camera unit in which a camera and a light source are arranged side by side on a substrate is provided, for example, on an instrument panel in front of a driver's seat, and images a driver's face. As a result, the occupant monitoring system performs image recognition processing based o the captured data of the camera, determines the driver and a state of the driver, and uses the result for, for example, driving assistance.

A camera unit is preferably provided at a central portion on an instrument panel. In this case, an optical axis of a light source and a camera need to be inclined so as to face a driver on the driver's seat. The camera unit is arranged at an angle with respect to a design surface on a front of the instrument panel in a state of having a gap when the camera unit is disposed to be inclined as described above. Therefore, an illumination light output from a light source is reflected by an inner surface of the design surface, the reflected light is directly input to the camera, and the reflected light becomes noise light, which may cause streaks in an image or so-called blown-out highlights, which may hinder image recognition.

In contrast to the comparative example, according to an occupant monitoring system of the present disclosure, an input of a noise light to a camera during imaging an occupant can be reduced.

According to one aspect of the present disclosure, an occupant monitoring system includes a camera unit provided in a vehicle compartment and captures an image of a face of an occupant in a vehicle as an imaging target. The camera unit includes a camera and a light source on a substrate. The camera forms a light path in which light from the light source is transmitted through a design surface to irradiate the imaging target and light reflected from the imaging target is transmitted through the design surface to be input to the camera. The camera unit includes a path prevention structure which prevents light from entering the camera through a path other than the light path.

### First Embodiment

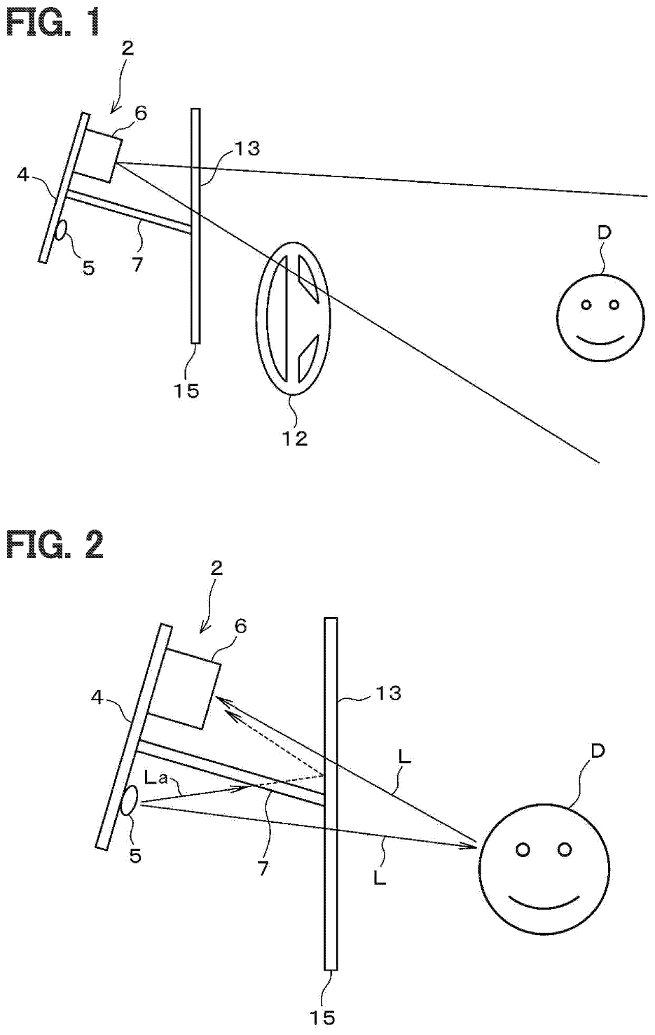

A first embodiment will be described with reference to FIGS. 1 to 5. FIG. 4 schematically shows an overall configuration of an occupant monitoring system 1 according to the present embodiment. The occupant monitoring system 1 is mounted on a vehicle, for example, an automobile. In this case, the occupant monitoring system 1 detects, for example, a driver as an occupant and monitors a state of the driver, for example, a face direction, an eye open state, or the like. The occupant monitoring system 1 includes a camera unit 2 and an image processing electronic control unit (ECU) 3 as an image processing unit.

As shown in FIGS. 1 and 2, the camera unit 2 has a light-emitting diode (LED) 5 as a light source and a camera 6 on a substrate 4. Further, in the present embodiment, the camera unit 2 has a light shielding wall 7 as a path prevention structure to be described later. The LED 5 is, for example, an infrared LED (IRLED) that outputs infrared light as illumination light. The camera 6 is, for example, an infrared camera. The camera unit 2 radiates an infrared light from the LED 5 toward a face of an occupant, in this case, the driver D (see FIG. 1), and to receive the reflected light by the camera 6 to image a face of the driver D. Details of the camera unit 2 will be described later.

Although not described in detail, the image processing ECU 3 mainly includes a computer including a calculation processing device (i.e., CPU) and peripheral devices thereof, and performs control of the LED 5 and the camera 6, image processing of captured data of the camera 6, and image recognition. In the image recognition processing, detection of the face of the driver D, detection of a part of the face from a feature point, detection of an orientation of the face and an eye open state, and the like are performed. The image processing ECU 3 and the camera unit 2 are incorporated in, for example, an instrument panel 15 (see FIG. 1, 3) of a vehicle compartment R.

As shown in FIG. 4, the image processing ECU 3 is unitized and connected to the camera unit 2 via a flexible cable and a connector. The image processing ECU 3 is connected to another in-vehicle ECU 8, for example, a driving assistance ECU, via a cable, a connector, and the like. Data of the face recognition of the driver D recognized by the occupant monitoring system 1 is used for a driving assistance process or the like.

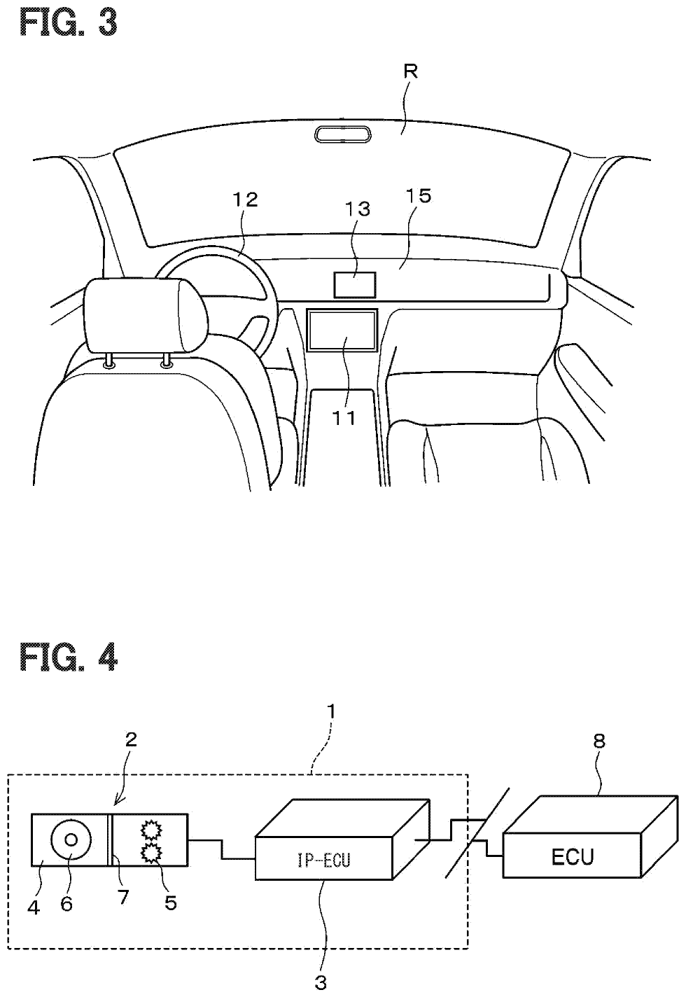

Next, the camera unit 2 will be described with reference to FIGS. 1 to 3. As shown in FIGS. 1, 2, the LED 5 and the camera 6 are provided on a front surface of the substrate 4. The camera unit also includes the light shielding wall 7 extending between the LED 5 and the camera 6 to be separated from each other by the light shielding wall 7. The camera unit 2 is provided in the instrument panel 15, and a predetermined gap is provided between a design surface of the instrument panel 15 and the LED 5 and the camera 6. As shown in FIG. 3, a center display 11 is provided on the design surface of a front surface of the instrument panel 15. The center display 11 is located at a middle area of the instrument panel 15 and displays various screens such as a navigation screen. A driver's seat is provided on a left in the vehicle compartment R, and a steering wheel 12 is provided in a front portion of the driver's seat.

The instrument panel 15 is provided with a monitor window portion 13 positioned above the center display 11. The monitor window portion 13 is configured such that the design surface of the instrument panel 15 has an opening portion which is opened in a slightly horizontally long rectangular shape, and an IR filter that mainly transmits an infrared light is arranged in the opening portion. As shown in FIG. 1, the camera unit 2 is arranged at a slightly distant position behind the monitor window portion 13 so as to face slightly diagonally forward so that the face of the driver D can be photographed through the monitor window portion 13.

Thus, in the camera unit 2, the LED 5 is turned on, the infrared light is output forward as the illumination light, and is emitted toward the face of the driver D on the driver's seat through the monitor window portion 13. Then, the reflected light from the face of the driver D is transmitted through the monitor window portion 13 and input to the camera 6. A path L of the infrared light and the reflected light is referred to as a normal path L. Captured data of the face of the driver D captured by the camera 6 is input to the image processing ECU 3, and the recognition processing of the face of the driver D is performed.

In the occupant monitoring system 1 according to the present embodiment, a path prevention structure that prevents light from being input to the camera 6 through a path other than the normal path L is provided. In the present embodiment, as shown in FIGS. 1, 2, the camera unit 2 has the light shielding wall 7 as a path prevention structure. The light shielding wall 7 extends between the LED 5 as a light source and the camera 6 to be separated from each other by the light shielding wall 7. The light shielding wall 7 has a thin plate shape elongated in a front-rear direction, and is painted, for example, in black so that a surface of the light shielding wall does not reflect light.

The light shielding wall 7 partitions the LED 5 and the camera 6 on the front surface of the substrate 4 by an imaginary plane including a thickness direction of the substrate 4. The light shielding wall 7 extends in the front-rear direction from the front surface of the substrate 4 to a rear surface of the monitor window portion 13 provided at the design surface of the instrument panel 15. Thus, the light shielding wall 7 prevents the light output from the LED 5 from being reflected by the design surface, for example, an inner surface of the monitor window portion 13 or an inner surface of the instrument panel 15 and input to the camera 6 without passing through the normal path L.

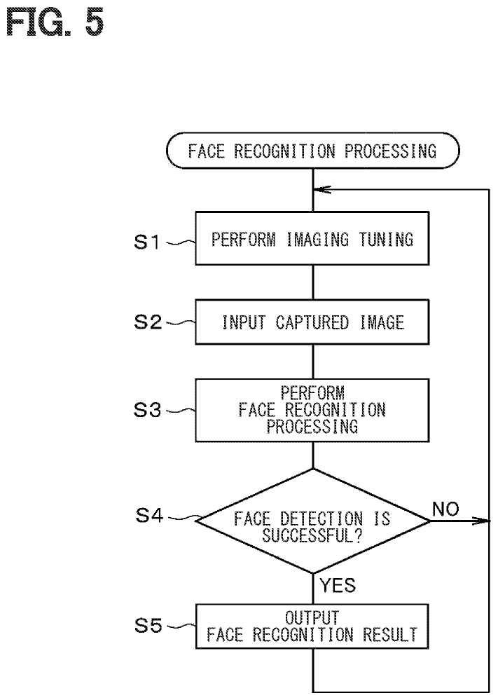

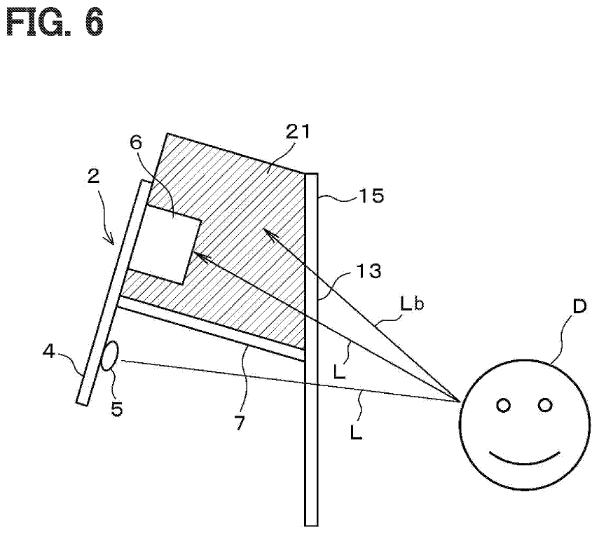

Next, actions of the occupant monitoring system 1 according to the present embodiment having the above-described configuration will be described with reference to FIG. 5. A flowchart of FIG. 5 schematically illustrates a procedure of image recognition processing of the driver D, which is executed by the image processing ECU 3 in the occupant monitoring system 1. That is, in step 51, the image processing ECU 3 performs imaging tuning of the camera unit 2, for example, illumination control of the LED 5, and the like, and in step S2, a captured image of the face of the driver D is input by the camera 6. In step S3, the recognition processing of the face of the driver D is executed based on the captured data of the camera 6.

In step S4, it is determined whether the face detection of the driver D is successful. If the face detection of the driver D is not successful (No in step S4), the process returns to step 51 and is repeated. On the other hand, when the face detection of the driver D is successful (Yes in step S4), the face recognition processing of the driver D is performed in step S5, and the result is output. Next, the process returns to step S1 and is repeated. The above processing is repeatedly executed at all times while the vehicle is traveling, and data of the face recognition result of the driver recognized by the occupant monitoring system 1 is used for driving assistance processing or the like.

The camera unit 2 is arranged in the instrument panel 15 at an angle with respect to the design surface in a state of having a gap. Therefore, there is a possibility that the illumination light output from the LED 5 is reflected on the design surface, that is, the monitor window portion 13 or the inner surface of the instrument panel 15, and is reflected toward the camera 6 on a path La different from the normal path Las shown FIG. 2. If the reflected light is directly input to the camera 6, the reflected light may become noise light and cause streaks in an image or so-called blown out highlights, which may hinder the image recognition.

However, in the present embodiment, since the light shielding wall 7 partitioning between the LED 5 and the camera 6 is provided as the path prevention structure, the reflected light is prevented from going to the camera 6 by the light shielding wall 7. Accordingly, an input of the noise light to the camera 6 can be reduced. Since the light shielding wall 7 is provided to extend from the substrate 4 to the design surface, leakage of light to the camera 6 is prevented in an entire region from the substrate 4 to the design surface.

As described above, the occupant monitoring system 1 of the present embodiment captures the image of the face of the driver D as the occupant with the camera 6, and recognizes the face of the driver D based on the captured data. The occupant monitoring system 1 includes the path prevention structure that prevents light from being input to the camera 6 through the path La other than the normal path L.

As a result, light from being input to the camera 6 through a path other than the normal path L can be prevented. Therefore, according to the present embodiment, the input of noise light to the camera 6 at a time of imaging by the driver D can be reduced.

In particular, in the present embodiment, as the path prevention structure, the light shielding wall 7 that partitions between the LED 5 and the camera 6 is provided. Thus, the light shielding wall 7 is capable of preventing the light output from the LED 5 from being reflected by the inner surface of the design surface and traveling toward the camera 6. Accordingly, the input of the noise light to the camera 6 can be reduced. Further, the light shielding wall 7 is a simple structure. Since the light shielding wall 7 is provided so as to extend from the substrate 4 to the design surface, the noise light from entering the camera 6 in the entire region from the substrate 4 to the design surface can be more effectively prevented.

### Second Embodiment and Other Embodiments

FIG. 6 shows a second embodiment. In the second embodiment, as a path prevention structure for preventing light from being input to the camera 6 through a path other than the normal path L, a non-reflective sheet 21 as an antireflection material portion is provided around the camera 6 in addition to the light shielding wall 7 described above. The non-reflective sheet 21 is made of, for example, a synthetic resin film colored in black, and is provided so as to cover, for example, a lower surface and a right side surface of a peripheral space in front of the camera 6, and is positioned between the design surface, that is, the instrument panel 15.

In the arrangement of the camera unit 2, the illumination light output from the LED 5 is transmitted through the monitor window portion 13 and is irradiated toward the face of the driver D in the driver's seat, and the reflected light from the face of the driver D is transmitted through the monitor window portion 13 and is incident thereon. Next, in the instrument panel 15, there is a possibility that an incident light Lb other than the normal path L is reflected by an object around the camera 6 and is input to the camera 6. However, in the present embodiment, by providing the non-reflective sheet 21 in the peripheral portion of the camera 6, the reflection of the incident light Lb is reduced, and the noise light is prevented from being input to the camera 6.

According to the second embodiment, as the path prevention structure, the non-reflective sheet 21 as the antireflection material portion is provided around the camera 6 in addition to the light shielding wall 7. As a result, similarly to the first embodiment, the face of the driver D as the occupant is imaged by the camera 6 and the face of the driver D is recognized based on the captured data, and excellent effects of reducing the input on the noise light to the camera 6 during imaging the driver D can be obtained.

In the present embodiment, the illumination light output from the LED 5 is reflected by the design surface by the light shielding wall 7, and is prevented from being reflected toward the camera 6 on the path La different from the normal path L. In addition, the non-reflective sheet 21 prevents the incident light La other than the normal path L, which is incident through the monitor window portion 13, from being reflected by an object around the camera 6 and input to the camera 6. Accordingly, the input of the noise light to the camera 6 can be more effectively reduced. In addition, since material of the non-reflective sheet 21 is adopted as the antireflection material, the non-reflective sheet 21 can be easily assembled, and an inexpensive and simple configuration can be realized.

In the second embodiment, both the light shielding wall 7 and the non-reflective sheet 21 are provided, but only the non-reflective sheet 21 may be provided. Even with the non-reflective sheet 21, the incident light Lb from being reflected by an object around the camera 6 and input to the camera 6 can be prevented. In each of the above embodiments, the camera unit 2 is provided in the middle area of the instrument panel. However, the camera unit 2 may be provided at an appropriate position in the vehicle compartment R, for example, at another position of the instrument panel or a meter portion in front of the driver's seat. In this case, a path prevention structure such as a light shielding wall or a prevention sheet can be provided at a position where necessary. Various materials can be adopted as the material of the antireflection material.

In each of the above embodiments, a case where the driver D is detected as the occupant has been described as an example, not limited to a case where the driver D is detected, and may be applied to a case where an occupant in a front passenger seat or a rear seat is detected. Although the present disclosure has been described in accordance with the examples, it is understood that the present disclosure is not limited to such examples or structures. The present disclosure encompasses various modifications and variations within the scope of equivalents. Additionally, various combinations and configurations, as well as other combinations and configurations including more, less, or only a single element, are within the scope and spirit of the present disclosure.

The control units and methods described in the present disclosure may be implemented by a special purpose computer provided by configuring a memory and a processor programmed to execute one or more functions embodied by a computer program. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer program may also be stored on a computer readable non-transitory tangible recording medium as instructions to be executed by a computer.

What is claimed is:

1. An occupant monitoring system comprising,
a camera unit provided in a vehicle compartment and configured to capture an image of a face of an occupant in a vehicle as an imaging target, wherein
the camera unit includes a camera and a light source on a substrate,
the camera is configured to form a light path in which light from the light source is transmitted through a design surface to irradiate the imaging target and light reflected from the imaging target is transmitted through the design surface to be input to the camera, and
the camera unit includes a path prevention structure configured to prevent light from entering the camera through a path other than the light path.

2. The occupant monitoring system according to claim 1, wherein
the path prevention structure includes a light shielding wall extending between the camera and the light source to be separated from each other by the light shielding wall.

3. The occupant monitoring system according to claim 2, wherein
the light shielding wall extends from the substrate to the design surface.

4. The occupant monitoring system according to claim 1, wherein
the path prevention structure includes a non-reflective part arranged around the camera.

5. The occupant monitoring system according to claim 4, wherein
the non-reflective part is a black non-reflective sheet and is provided between a front of the camera and the design surface.

6. An occupant monitoring system comprising,
a camera unit provided in a vehicle compartment and configured to capture an image of a face of an occupant in a vehicle as an imaging target, wherein
the camera unit includes a camera and a light source on a substrate,
the camera is configured to form a light path in which light from the light source is transmitted through a design surface to irradiate the imaging target and light reflected from the imaging target is transmitted through the design surface to be input to the camera,
the camera unit includes a path prevention wall configured to prevent light from entering the camera through a path other than the light path,
the path prevention wall includes a light shielding wall extending between the camera and the light source to be separated from each other by the light shielding wall,
the light shielding wall extends from the substrate to the design surface, and
a surface of the light shielding wall is not configured to reflect light.
